(19) United States
(12) Patent Application Publication
(10) Pub. No.: US 2009/0041977 A1
(43) Pub. Date: Feb. 12, 2009

(54) System for the Manufacture of Electronic Assemblies Without Solder

(75) Inventor: Joseph C. Fjelstad, Maple Valley, WA (US)

Correspondence Address: The TPL Group, 20400 Stevens Creek Blvd., Fifth Floor, Cupertino, CA, 95014, US

(73) Assignee: OCCAM PORTFOLIO LLC, Cupertino, CA (US)

(21) Appl. No.: 12/187,323

(22) Filed: Aug. 6, 2008

Related U.S. Application Data
(63) Continuation-in-part of application No. 12/119,287, filed on May 12, 2008.
Application No. 12/119,287 is a continuation-in-part of application No. 12/163,870, filed on Jun. 27, 2008.
Application No. 12/163,870 is a continuation-in-part of application No. PCT/US08/65131, filed on May 29, 2008.
Application No. PCT/US08/65131 is a continuation-in-part of application No. 12/170,426, filed on Jul. 9, 2008.
Application No. 12/170,426 is a continuation-in-part of application No. 12/182,043, filed on Jul. 29, 2008.
(60) Provisional application No. 60/963,822, filed on Aug. 6, 2007.
(60) Provisional application No. 60/966,643, filed on Aug. 28, 2007.
(60) Provisional application No. 61/038,564, filed on Mar. 21, 2008.
(60) Provisional application No. 61/039,059, filed on Mar. 24, 2008.
(60) Provisional application No. 61/075,238, filed on Jun. 24, 2008.

(51) Int. Cl. B32B 3/24; B32B 37/00; B32B 43/00; B32B 3/02

(52) U.S. Cl. 428/131; 156/349; 156/390; 156/378; 428/156

(57) ABSTRACT

The present invention provides an electronic assembly 400 and a machine 800 for its manufacture. The assembly 400 has no solder. Components 406, or component packages 402, with I/O leads 412 sit on a planar substrate. The machine 800 encapsulates the components 406 or component packages, with electrically insulating material with vias 420 extending through the substrate to the components' leads 412. Then the machine 800 plates the components' leads and forms traces. Next, the machine 800 covers the plated material with electrically insulating material. Additional vias may extend through the material covering the plated material and in turn be plated and covered. The machine 800 repeats the formation of vias, plating, and coverings of the assembly as desired.

### CROSS-REFERENCE TO RELATED APPLICATIONS

This application claims the benefit of U.S. Provisional Application No. 60/963,822, filed on Aug. 6, 2007, hereby incorporated by reference in its entirety; U.S. Provisional Application No. 60/966,643, filed on Aug. 28, 2007, hereby incorporated by reference in its entirety; U.S. Provisional Application No. 61/038,564, filed on Mar. 21, 2008, hereby incorporated by reference in its entirety; U.S. Provisional Application No. 61/039,059 filed on Mar. 24, 2008, hereby incorporated by reference in its entirety; and U.S. Provisional Application No. 61/075,238 filed on Jun. 24, 2008, hereby incorporated by reference in its entirety.

This application is a continuation-in-part application of pending U.S. patent application Ser. No. 12/119,287, ELECTRONIC ASSEMBLIES WITHOUT SOLDER AND METHODS FOR THEIR MANUFACTURE; U.S. patent application Ser. No. 12/163,870, ELECTRONIC ASSEMBLIES WITHOUT SOLDER AND METHODS FOR THEIR MANUFACTURE; PCT Patent Application No. PCT/US2008/065131, ELECTRONIC ASSEMBLIES WITHOUT SOLDER AND METHODS FOR THEIR MANUFACTURE; U.S. patent application Ser. No. 12/170,426, ELECTRONIC ASSEMBLIES WITHOUT SOLDER AND METHODS FOR THEIR MANUFACTURE; and U.S. patent application Ser. No. 12/182,043, ASSEMBLY OF ENCAPSULATED ELECTRONIC COMPONENTS TO A PRINTED CIRCUIT BOARD; hereby incorporated by reference in their entirety.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to the field of electronic assembly and more specifically to the manufacture and assembly of solderless electronic products.

### BACKGROUND ART

Historically, most electronic products have been assembled using a solder material and a soldering process. This has always had disadvantages, and a number of new trends are revealing or exacerbating other disadvantages.

One set of such disadvantages relates to solder materials. Tin/lead type solders (e.g., Sn63/Pb37) have been widely used since the earliest days of the electronics industry. Unfortunately, both tin and especially lead have serious chemical disadvantages. For these two metals, mining the ores, refining those ores, working with the refined metals during manufacturing, being exposed to substances including these in manufactured products, and disposing of the products at the ends of their life cycles are all potentially damaging to human and animal health and to the environment.

Recently human health and environmental concerns about tin/lead type solders have resulted in the Directive on the Restriction of the Use of Certain Hazardous Substances in Electrical and Electronic Equipment (commonly referred to as the Restriction of Hazardous Substances Directive or RoHS) in the European Union. This directive restricts the use of six hazardous materials, including lead, in the manufacture of various types of electronic and electrical equipment. This directive is also closely linked with the Waste Electrical and Electronic Equipment Directive (WEEE) 2002/96/EC, which sets collection, recycling, and recovery targets for electrical goods. Together these directives are part of a growing world-wide legislative initiative to solve the problem of electronic device waste.

To some extent the electronics industry has always been searching for a practical substitute for tin/lead type solders, and legislative initiatives like those just noted are now motivating a number of changes. Today a common substitute for tin/lead type solders are SAC type solder varieties, which are alloys containing tin (Sn), silver (Ag), and copper (Cu). But this is merely a compromise. Mining, refining, working during manufacturing, exposure from manufactured products, and disposal are still all issues for tin, silver, and copper. Furthermore, SAC solder processes are prone to other problems, such as the formation of shorts (e.g., “tin whiskers”) and opens if surfaces are not properly prepared. It follows that the undue use of some materials, like those in solders, are generally undesirable in electronic assemblies.

Another set of disadvantages in the solder-based assembly of electronic products is the high temperature processes that are inherently required. The use of heat on and around many electronic components has always been undesirable. As a general principle, the heating of electronic components increases their failure rate in later use and beyond a certain point outright destroys such components. Tin/lead solders melt at relatively low temperatures and their use has generally been tolerable for many components. This is not always the same for SAC type solders, which melt at much higher temperatures (e.g., ˜40° C. or hotter). The likelihood of component damage is much higher, resulting in assemblies that fail during post-manufacturing testing as well as in-the-field failures. Additionally, generating and managing the heat during manufacturing have increased energy, safety, and other costs. It therefore follows that the undue use of heat-based manufacturing processes, like soldering, is also generally undesirable in electronic assemblies.

Increasingly yet another set of disadvantages in the solder-based assembly of electronic products is one related to the “adding” of materials. When a material, like solder, is added between two components to hold them together the additional material inherently has to occupy some space. Solder contains dense metals, which adds to the ultimate weight of electronic products. The use of liquid-state materials, like liquid stage solder during manufacturing, often requires designing in additional space around leads, terminals, and connection pads to account for the ability of the liquid to flow easily and to potentially short to other leads, terminals, pads, etc. Liquid solders have high surface tensions and effects from this also usually require major design consideration. These are all factors that can require consideration as designers increasingly strive to miniaturize electronic assemblies. Accordingly, it further follows that the undue use of any additional material in manufactured assemblies and in manufacturing processes, again like solder, is generally undesirable in the resulting electronic assemblies.

FIG. 1 shows a prior completed assembly 100, with solder joint 110, of a gull wing component package 104 solder-mounted on a PCB 102.

Component package 104 contains electrical component 106. The component 106 may be either an IC or another discrete component. Gull wing lead 108 extends from package 104 to flow solder 110 which in turn connects lead 108 to pad 112 on PCB 102. Insulating material 114 prevents flow solder 110 from flowing to and shorting component 106 with other components (not shown) on PCB 102. Pad 112 connects to through hole 118 which in turn connects to proper traces such as ones indicated by 116. In addition to the aforementioned problems with solder joints, this type of assembly, including the internal structure of PCB 102, is complex and requires height space that is reduced in the present invention.

FIG. 2 shows a prior completed assembly 200, with solder joint 202, of either a BGA IC or an LGA IC package 204 on a PCB 214. A primary difference from FIG. 1 is the use of ball solder 202 as opposed to flow solder 110.

Component package 204 contains component 206. Lead 208 extends from package 204 through support 210 (typically composed of organic or ceramic material) to ball solder 202 which in turn connects lead 208 to pad 212 on PCB 214. Insulating material 216 prevents ball solder 202 from shorting other leads (not shown) contained in package 204. Insulating material 218 prevents ball solder 202 from flowing to and shorting component 206 with other components (not shown) on PCB 214. Pad 212 connects to through hole 220 which in turn connects to proper traces such as ones indicated by 222. The same problems are present with this configuration as with the assembly shown in FIG. 1: In addition to the aforementioned problems with solder joints, this type of assembly is complex, particularly because of the PCB 214, and requires height space that is reduced in the present invention.

FIG. 3 illustrates a prior solderless connection assembly 300. See U.S. Pat. No. 6,160,714 (Green). In this configuration, substrate 302 supports a package 304. Package 304 contains an electrical component (not shown) such as an IC or other discrete component. Overlying substrate 302 is insulating material 306. On the other side of the substrate 302, is a conductive, polymer-thick-film ink 308. To improve conductivity, a thin film of copper is plated 310 on polymer-thick-film 308. A via extends from the package 304 through substrate 302. The via is filled with a conductive adhesive 314. The point of attachment 316 of package 304 to adhesive 314 may be made with fusible polymer-thick-film ink, silver polymer-thick-film conductive ink, or commercial solder paste. One disadvantage of this prior art assembly over the present invention is the additional thickness added by the adhesive 314 as illustrated by bump 318.

### BRIEF SUMMARY OF THE INVENTION

It is an object of the present invention to provide an apparatus to join electrical components without solder.

The present invention provides an apparatus (machine) for producing an electronic assembly. The apparatus places components (optionally pre-tested and burned in) including electrical, electronic, electro-optical, electro-mechanical and user interface devices with external I/O contacts onto a planar base. The apparatus encapsulates the components with a solder mask, dielectric, or electrically insulating material (collectively referred to as “insulating material” in this application including claims) with holes, known as vias, formed or drilled through to the components' leads, conductors, and terminals (collectively referred to as “leads” in this application including claims). Then the apparatus plates the assembly and repeats the encapsulation and drilling steps to build up desired layers.

The apparatus builds the assembly with this novel reverse-interconnection process (RIP) using no solder, and thus bypassing the use of lead, tin, and heat associated problems. The term “reverse” refers to the reverse order of assembly; the apparatus places components first and then manufactures circuit layers rather than creating a PCB first and then mounting components. No conventional PCB is required (although one may be optionally integrated), shortening manufacturing cycle time, reducing costs and complexity, and lessening PCB reliability problems.

This and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 is a cross-sectional view of a prior solder assembly employing a gull wing component on a PCB.

FIG. 2 is a cross-sectional view of a prior solder assembly employing either a Ball Grid Array (BGA) or a Land Grid Array (LGA) component on a PCB.

FIG. 3 is a cross-sectional view of a prior solderless assembly employing an electrical component.

FIG. 4 is a cross-sectional view of a portion of a RIP assembly employing an LGA component.

FIG. 5 is a cross-sectional view of a portion of a RIP assembly employing an LGA component with an optional heat spreader and heat sink.

FIG. 6 is a cross-sectional view of a two layer RIP assembly showing mounted discrete, analog, and LGA components.

FIG. 7 is a cross-sectional view of a pair of mated two layer RIP subassemblies.

FIG. 8 is a cross-sectional view of a machine 800 used in the manufacture of a representative RIP assembly.

In the various figures of the drawings, like references are used to denote like or similar elements or steps.

In the following description and in the accompanying drawings, specific terminology and drawing symbols are set forth to provide a thorough understanding of the present invention. In some instances, the terminology and symbols may imply specific details that are not required to practice the invention. For example, the interconnection between conductor elements of components (i.e., component I/O leads) may be shown or described as having multi-conductors interconnecting to a single lead or a single conductor signal line connected to multiple component contacts within or between devices. Thus each of the multi-conductor interconnections may alternatively be a single-conductor signaling, control, power or ground line and vice versa. Circuit paths shown or described as being single-ended may also be differential, and vice-versa. The interconnected assembly may be comprised of standard interconnections; microstrip or stripline interconnections and all signal lines of the assembly may be either shielded or unshielded.

### DETAILED DESCRIPTION OF THE INVENTION

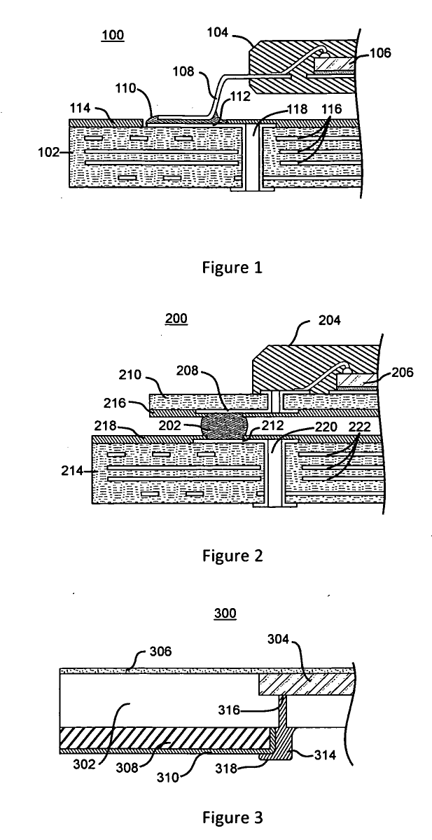

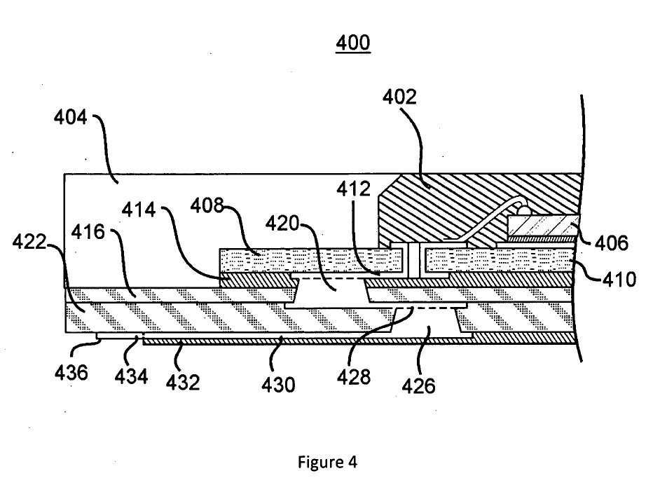

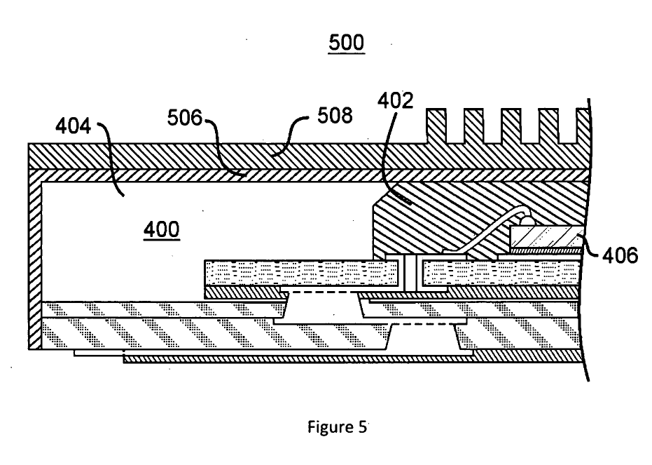

FIG. 4, an assembly 400 illustrative of the product of the present invention, shows an LGA component package (402, 406, 408, 410, 412, 414) mounted on a substrate 416 which does not have to be a PCB. It will be obvious to one skilled in the art that a BGA, gull wing, or other IC package structure or any type of discrete component may substitute for the LGA component. The connection is simpler, solder free, and lower profile than the assemblies shown in FIGS. 1, 2, and 3.

Adhering to package 402 is electrically insulating material 404. Material 404 is shown attached to 1 side of package 402. However, material 404 may be attached to 2 sides of package 402, more than 2 sides of package 402, or may in fact envelop package 402. As applied, material 404 may give the assembly strength, stability, structural integrity, toughness (i.e., it is non-brittle), and dimensional stability. Material 404 may be reinforced by the inclusion of a suitable material such as a glass cloth.

Component package 402 contains electrical component 406 (such as an IC, discrete, or analog device; collectively referred to as “component” in this application including claims), supports 408 and 410 (preferably composed of organic or ceramic material), lead 412, and insulating material 414. While component package 402, as manufactured and shipped in many cases, incorporates insulating material 414, this legacy feature may potentially be eliminated in the future thus reducing the profile of the assembly 400. Alternatively, material 414 may include additional material (for example heat activated adhesive) to bond component package 402 to substrate 416.

Either supports 408 and 410 or, if present, insulating material 414 sit on substrate 416 which is preferably made of insulating material. Some portion or all of substrate 416 may be made of electrically conductive material if it is desired to short leads (e.g., 412) extending from package 402.

Attachment of lead 412 to insulating material 414 and substrate 416 may be realized by adhesive dots as well as by other well known techniques including use of tacky or pressure sensitive adhesive films. The substrate may be permanently or temporally attached to lead 412 and material 414.

A first set of vias, an example of which is via 420, extends through substrate 416, extends through insulating material 414, if present, reaches, and exposes leads such as lead 412. The vias 420 are plated or filled with an electrically conductive material (in many cases copper (Cu), although silver (Ag), gold (Au), or aluminum (Al) as well as other suitable materials, may be substituted). The plate or fill fuse with leads 412 forming an electrical and mechanical bond.

The substrate 416 may include a pattern mask (not shown) which is plated, or the plate or fill introduced into the first set of vias (e.g., via 420) may extend under the substrate 416 and provide a required first set of traces. Other traces may be created. A layer 422, also of insulating material, may underlay substrate 416 and first traces. The purpose of 422 is to provide a platform for a second set of traces (if required) and to electrically insulate the first set of traces from the second set of traces.

A second set of vias, an example of which is via 426, extends through layer 422, reaches, and exposes traces and/or leads (e.g., lead 428) under substrate 416. As discussed above, referring to the first set of vias (e.g., via 420), the second set of vias may be plated or filled so that they fuse with desired leads (e.g., lead 428) under substrate 416. As above, one or more traces 430 may extend under layer 422.

This layering continues as needed. By repeating the above structure, multiple layers (not shown), and additional traces and vias may be built. A surface insulating material 432 under coats the last layer. Leads or electrical connectors (e.g., lead 434) may extend beyond the surface insulating material 432. This provides contact surfaces (e.g., surface 436) to permit connection with other electrical components or circuit boards.

FIG. 5, assembly 500, shows optional heat dissipation features of the product. Assembly 400, previously described in FIG. 4, may have on top of the package 402 and material 404 a heat spreader 506 and/or a heat sink 508 to dissipate heat generated by component 406. A thermal interface material (not shown) may be used to join the heat sink to the heat spreader. Optionally, material 404 may include in its composition a heat conductive (although electrically insulating) material such as silicon dioxide (SiO₂) or aluminum dioxide (AlO₂) to enhance heat flow from package 402. If heat spreader 506 and heat sink 508 are made of one or more substances well known in the art, they may provide electromagnetic interference (EMI) protection to the assembly 400 and help protect against static electricity discharges.

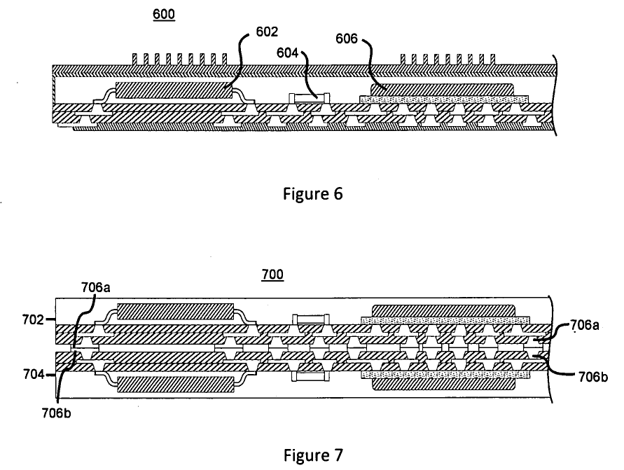

In accordance with a two layer RIP assembly product, a section of which is shown in FIG. 5, FIG. 6 shows assembly 600 with a mounted sample set of components, including a discrete gull wing component 602, an analog component 604, and an LGA IC 606.

It will be apparent to someone skilled in the art that the RIP assembly is less complicated than a PCB containing soldered components. That is, just a PCB by itself is a complex device requiring dozens of steps to manufacture. The RIP assembly, by not requiring a PCB board, is simpler and requires fewer steps to manufacture a complete electronic assembly.

As an option, the FIG. 7 assembly product 700 shows two RIP subassemblies, 702 and 704, joined together at the plated and/or filled vias (e.g., 706a, 706b) and/or at the leads (e.g., 708a, 708b).

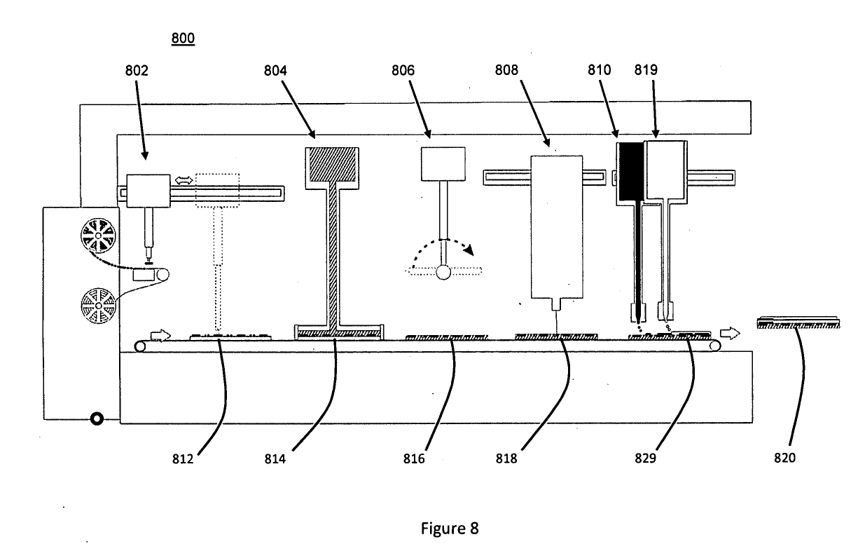

FIG. 8 shows a cross-section of a machine 800 created in accordance with the present invention. Equipment 802 picks electrical components and places them onto a substrate 812, temporary or permanent, or a foil firmament. Equipment 804 envelopes the components with electrically insulating material. Temporary substrate 814, if present, may be removed at this point. Then, optionally, equipment 806 may turn over subassembly 816.

Then equipment 808 drills vias in a permanent substrate, if present, exposing electrical component leads on assembly 818. Or molding equipment (not shown) may have pre-formed vias in substrate 812. Next, device 810 plates the surface of subassembly 829 with electrically conductive material forming traces and a second set of leads filling vias so that the vias and component leads are electrically connected to the traces and the second set of leads. After device 810 finishes building traces and leads, device 819 lays down a layer of electrically insulating material on subassembly 829. The resulting product is assembly 820 shown in greater detail in FIG. 4, assembly 400.

Features of machine 800 may be modified and still be within the spirit and scope of this application. For example, the features of machine 800 may be divided among two or more machines to accomplish the same or equivalent result. Thus, for the purpose of this application, the term “machine” encompasses “one or more machines” used to create the assembly or a subassembly.

An example of a feature of machine 800 which may be eliminated is the equipment 806 within the machine 800 used to turn over the subassembly after applying and/or enveloping the subassembly 816 with electrically insulating material. That is, for example, drilling vias may be done from below and likewise plating may be done by printing and electrically insulting material covering the plating may be sprayed on, both also from below.

In addition, the machine 800 may repeat the execution of one or more steps. For example, the machine 800 may shuttle back and forth among the steps of forming vias, plating vias and leads, and laying electrical insulating material over the plating. Shuttling in this manner would have the effect of building layers of circuits to function as the prior art PCB layers of circuits.

The foregoing description details specific embodiments of the invention and are included for illustrative purposes. However, it will be apparent to one skilled in the art that many combinations and permutations of the described embodiments are possible while remaining within the scope and spirit of the invention. For example, numerous similar or different types of electrical components may be incorporated into assemblies by the present machine 800. Examples of types of electrical components include, but are not limited to, discrete or analog components, gull wing components, IC, LGA, BGA, CGA, QFN, QFP, TSOP, OFN, and PGA components, and other lead frame package and area array components. Preferably such components are fully tested and burned in before being integrated into a RIP assembly.

As indicated above, this application is a continuation-in-part of applications U.S. patent application Ser. Nos. 12/119,287, 12/163,870, 12/170,426, 12/182,043, and PCT Patent Application No. PCT/US2008/065131, hereby incorporated by reference in their entirety. The apparatus of the present invention may be used during the manufacture of various types of assemblies as disclosed and described in the above referenced applications. That is, a subassembly manufactured by the apparatus of the present machine can be attached to heat spreaders and heat sinks (Ser. No. 12/119,287). The substrate may be flexible (Ser. No. 12/163,870). Duplicates of the subassembly may be mounted front to front or back to back (Ser. No. 12/119,287 and PCT/US2008/065131). The subassembly may be mounted on a foil base (Ser. No. 12/170,426). And the subassembly may be joined and interconnected to a central bonding material which is connected to a PCB (Ser. No. 12/182,043).

While various embodiments have been described above, it should be understood that they have been presented by way of example only, and that the breadth and scope of the invention should not be limited by any of the above described exemplary embodiments, but should instead be defined only in accordance with the following claims and their equivalents.

I claim:

1. An apparatus comprising a machine capable of performing the following steps in order:
wherein a first step comprises placing at least one component package on a substrate, the component package having at least one side, the substrate having a first planar side and a second planar side,
wherein a second step comprises incorporating a first electrically insulating material, the insulating material attaching at least one side of the at least one component package to the first planar side of the substrate.

2. The apparatus of claim 1 further capable of performing the following steps:
wherein a third step comprises turning the substrate over and removing the substrate, and,
wherein a fourth step comprises plating one or more component leads with electrically conductive material to form one or more traces on the first electrically insulating material.

3. The apparatus of claim 1 further capable of performing the following steps:
wherein a third step comprises turning the substrate over,
wherein a fourth step comprises forming one or more vias extending through the substrate and exposing a first set of one or more leads of the at least one component package, and
wherein a fifth step comprises plating the second planar surface with electrically conductive material to form a second set of one or more leads so that the one or more vias are filled with the electrically conductive material and the first set of one or more leads is in electrical communication with the second set of one or more leads.

4. The apparatus of claim 2 further capable of performing the following step:
wherein a fifth step comprises depositing a layer of second electrically insulating material on the electrically conductive material.

5. The apparatus of claim 3 further capable of performing the following step:
wherein a sixth step comprises depositing a layer of second electrically insulating material on the electrically conductive material.

6. The apparatus of claim 4 further capable of performing the following step:
wherein a sixth step comprises forming a first set of at least one via through the second electrically insulating material exposing a first set of at least one lead of the at least one component package.

7. The apparatus of claim 5 further capable of performing the following step:
wherein a seventh step comprises forming a first set of at least one via through the second electrically insulating material exposing a first set of at least one lead of the at least one component package.

8. The apparatus of claim 1 wherein the least one component package is tested and burned in.

9. An apparatus comprising a machine capable of performing the following steps in order:
wherein a first step comprises placing at least one component package on a substrate, the component package having at least one side, the substrate having a first planar side and a second planar side,
wherein a second step comprises incorporating a first electrically insulating material, the insulating material attaching at least one side of the at least one component package to the first planar side of the substrate,
wherein a third step comprises removing the substrate and plating one or more component leads to form one or more traces on the first electrically insulating material, and,
wherein a fourth step comprises depositing a layer of second electrically insulating material on the electrically conductive material.

10. A product manufactured by the machine of claim 1.

11. A product manufactured by the machine of claim 2.

12. A product manufactured by the machine of claim 3.

13. A product manufactured by the machine of claim 4.

14. A product manufactured by the machine of claim 5.

15. A product manufactured by the machine of claim 6.

16. A product manufactured by the machine of claim 7.

17. A product manufactured by the machine of claim 9.
